(19) United States
(12) Patent Application Publication
(10) Pub. No.: US 2018/0194009 A1
(43) Pub. Date: Jul. 12, 2018

(54) ROBOT CONTROL DEVICE AND ROBOTIC SYSTEM

(71) Applicant: Seiko Epson Corporation, Tokyo (JP)

(72) Inventors: Tsuguya KOJIMA, Chino (JP); Masato YOKOTA, Azumino (JP); Toshiyuki ISHIGAKI, Azumino (JP); Naoki UMETSU, Mikawa (JP); Yoshito MIYAMOTO, Matsumoto (JP)

(21) Appl. No.: 15/863,036

(22) Filed: Jan. 5, 2018

(30) Foreign Application Priority Data
Jan. 11, 2017 (JP) 2017-002412

(51) Int. Cl. B25J 9/16; B25J 13/08; B25J 15/00

(52) U.S. Cl. CPC B25J 9/1692; B25J 9/0018; B25J 15/0019; B25J 13/085

(57) ABSTRACT

A robot control device includes a processor that is configured to execute computer-executable instructions so as to control a robot provided with a manipulator having a plurality of joints, wherein the processor is configured to: display an area, in which a second predetermined position of the robot can move so that a first predetermined position of the robot does not pass through a singular point, in a display.

### BACKGROUND

### 1. Technical Field

The present invention relates to a robot control device and a robotic system.

### 2. Related Art

There have been conducted research and development of a technology for making a robot perform a predetermined operation.

Regarding the above, there has been known a technology of making each of the plurality of joints provided to a robot perform a continuous path operation, which is an operation due to continuous path (CP) control, to thereby make the robot perform a predetermined operation (see JP-A-2016-147323).

Here, in the case in which the posture of the robot approximates to a singular configuration in the continuous path operation, at least one of the joints provided to the robot rotates at a velocity (i.e., a rotational velocity or an angular velocity) exceeding a limit velocity in some cases. The singular configuration denotes the posture of the robot in the case in which the P-point of the robot coincides with a singular point. Further, the P-point denotes an imaginary point representing the position and the posture of the robot, and is the point, the position and the posture of which can be calculated based on the rotational angles of the respective joints. There is a possibility that a failure occurs in the joint continuing to rotate at the velocity exceeding the limit velocity. Therefore, in such a case, the robot determines that an error occurs and stops the operation in some cases.

### SUMMARY

An aspect of the invention is directed to a robot control device includes a processor that is configured to execute computer-executable instructions so as to control a robot provided with a manipulator having a plurality of joints, wherein the processor is configured to: display an area, in which a second predetermined position of the robot can move so that a first predetermined position of the robot does not pass through a singular point, in a display.

According to this configuration, the robot control device displays the area in which the second predetermined position of the robot can move so that the first predetermined position of the robot does not pass through the singular point. Thus, it is possible for the robot control device to help the user to determine the work area of the robot.

In another aspect of the invention, the robot control device may be configured such that the first predetermined position is a same position as the second predetermined position.

According to this configuration, in the robot control device, the first predetermined position is the same position as the second predetermined position. Thus, it is possible for the robot control device to provide the user with the area where the first predetermined position can move as a candidate for the work area of the robot.

In another aspect of the invention, the robot control device may be configured such that the processor is configured to move the second predetermined position in the area with continuous path control.

According to this configuration, the robot control device moves the second predetermined position using the continuous path control in the area in which the second predetermined position can move so that the first predetermined position of the robot does not pass through the singular point. Thus, it is possible for the robot control device to determine the area, in which the second predetermined position can move so that the first predetermined position does not pass through the singular point, as the work area of the robot, and make the robot perform a predetermined operation due to the continuous path control.

In another aspect of the invention, the robot control device may be configured such that the processor is configured to correct a path in the continuous path control based on a posture of an object calculated based on a taken image obtained by imaging the object, and move the second predetermined position along the path corrected with the continuous path control.

According to this configuration, the robot control device corrects the path in the continuous path control based on the posture of the object calculated based on the taken image obtained by imaging the object, and moves the second predetermined position along the path corrected with the continuous path control. Thus, it is possible for the robot control device to make the robot accurately perform the predetermined operation even in the case in which the posture of the object is shifted from the desired posture.

In another aspect of the invention, the robot control device may be configured such that a work area of the robot is an inside of the area.

According to this configuration, in the robot control device, the work area of the robot is the inside of the area in which the second predetermined position of the robot can move so that the first predetermined position of the robot does not pass through the singular point. Thus, it is possible for the robot control device to make the robot perform a predetermined operation in the inside of the area in which the second predetermined position can move so that the first predetermined position does not pass through the singular point.

Another aspect of the invention is directed to a robotic system including a robot provided with a manipulator having a plurality of joints, and a robot control device including a processor that is configured to execute computer-executable instructions so as to control the robot, wherein the processor is configured to: display an area, in which a second predetermined position of the robot can move so that a first predetermined position of the robot does not pass through a singular point, in a display.

According to this configuration, the robotic system displays the area in which the second predetermined position of the robot can move so that the first predetermined position of the robot does not pass through the singular point. Thus, it is possible for the robotic system to help the user to determine the work area of the robot.

In another aspect of the invention, the robotic system may be configured such that the robot is provided with a dispenser.

According to this configuration, the robotic system displays the area in which the second predetermined position of the robot provided with the dispenser can move so that the first predetermined position of the robot does not pass through the singular point. It is possible to help the user to determine the work area of the robot provided with the dispenser.

In another aspect of the invention, the robotic system may be configured such that the robot is provided with an end effector.

According to this configuration, the robotic system displays the area in which the second predetermined position of the robot provided with the end effector can move so that the first predetermined position of the robot does not pass through the singular point. Thus, it is possible for the robotic system to help the user to determine the work area of the robot provided with the end effector.

In another aspect of the invention, the robotic system may be configured such that the robot is provided with a force sensor.

According to this configuration, the robotic system displays the area in which the second predetermined position of the robot provided with the force sensor can move so that the first predetermined position of the robot does not pass through the singular point. Thus, it is possible for the robotic system to help the user to determine the work area of the robot provided with the force sensor.

In another aspect of the invention, the robotic system may be configured such that the robot includes an n-th (n is an integer no lower than 1) arm capable of rotating around an n-th rotational axis, and an (n+1)-th arm connected to the n-th arm so as to be able to rotate around an (n+1)-th rotational axis having a different axial direction from an axial direction of the n-th rotational axis, and the n-th arm and the (n+1)-th arm can overlap each other viewed from the axial direction of the (n+1)-th rotational axis.

According to this configuration, the robotic system displays the area in which the second predetermined position of the robot, in which the n-th arm and the (n+1)-th arm can overlap each other viewed from the axial direction of the (n+1)-th rotational axis, can move so that the first predetermined position of the robot does not pass through the singular point. Thus, it is possible for the robotic system to help the user to determine the work area of the robot, in which the n-th arm and the (n+1)-th arm can overlap each other viewed from the axial direction of the (n+1)-th rotational axis.

In another aspect of the invention, the robotic system may be configured such that a length of the n-th arm is longer than a length of the (n+1)-th arm.

According to this configuration, the robotic system displays the area in which the second predetermined position of the robot, in which the length of the n-th arm is longer than the length of the (n+1)-th arm, can move so that the first predetermined position of the robot does not pass through the singular point. Thus, it is possible for the robotic system to help the user to determine the work area of the robot in which the length of the n-th arm is longer than the length of the (n+1)-th arm.

In another aspect of the invention, the robotic system may be configured such that the n-th arm (n is 1) is disposed on a base.

According to this configuration, the robotic system displays the area in which the second predetermined position of the robot having the n-th arm (n is 1) disposed on the base can move so that the first predetermined position of the robot does not pass through the singular point. Thus, it is possible for the robotic system to help the user to determine the work area of the robot having the n-th arm (n is 1) disposed on the base.

In another aspect of the invention, the robotic system may be configured such that the robot is installed in a cradle.

According to this configuration, the robotic system displays the area in which the second predetermined position of the robot installed in the cradle can move so that the first predetermined position of the robot does not pass through the singular point. Thus, it is possible for the robotic system to help the user to determine the work area of the robot installed in the cradle.

According to the above, the robot control device and the robotic system display the area in which the second predetermined position of the robot can move so that the first predetermined position of the robot does not pass through the singular point. Thus, it is possible for the robot control device and the robotic system to help the user to determine the work area of the robot.

### BRIEF DESCRIPTION OF THE DRAWINGS

The invention will be described with reference to the accompanying drawings, wherein like numbers reference like elements.

FIG. 1 is a diagram showing an example of a configuration of a robotic system 1 according to an embodiment of the invention.

FIG. 2 is a diagram showing an example of a configuration of a robot.

FIG. 3 is a diagram showing an example of a side view of the robot shown in FIG. 1 and FIG. 2.

FIG. 4 shows an example of a front view of the robot in the case of viewing the robot shown in FIG. 3 from the positive direction of the Y axis in a robot coordinate system toward the negative direction of the Y axis.

FIG. 5 is a diagram for explaining an operation going through a compact state out of the operations of a manipulator.

FIG. 6 is a diagram showing an example of a hardware configuration of a robot control device.

FIG. 7 is a diagram showing an example of a functional configuration of the robot control device.

FIG. 8 is a flowchart showing an example of a flow of an area display process performed by the robot control device.

FIG. 9 is a diagram showing an example of an area display screen.

FIG. 10 is a flowchart showing an example of a flow of a process of the robot control device for making the robot perform a predetermined operation.

FIG. 11 is a diagram showing an example of an appearance in which the position and the posture of a control point coincide with an operation starting position and an operation starting posture.

FIG. 12 is a diagram showing an example of an appearance in which the control point coincides with a certain second teaching point out of one or more second teaching points represented by teaching point second information.

### DESCRIPTION OF AN EXEMPLARY EMBODIMENT

### Embodiment

An embodiment of the invention will hereinafter be described with reference to the accompanying drawings.

### Configuration of Robotic System

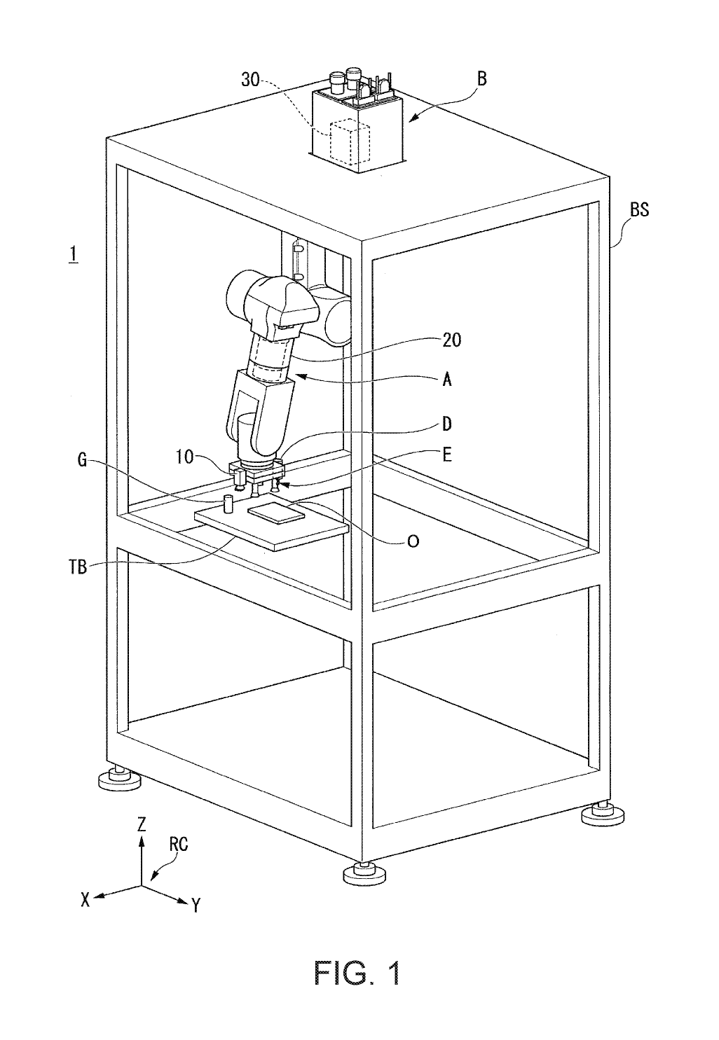

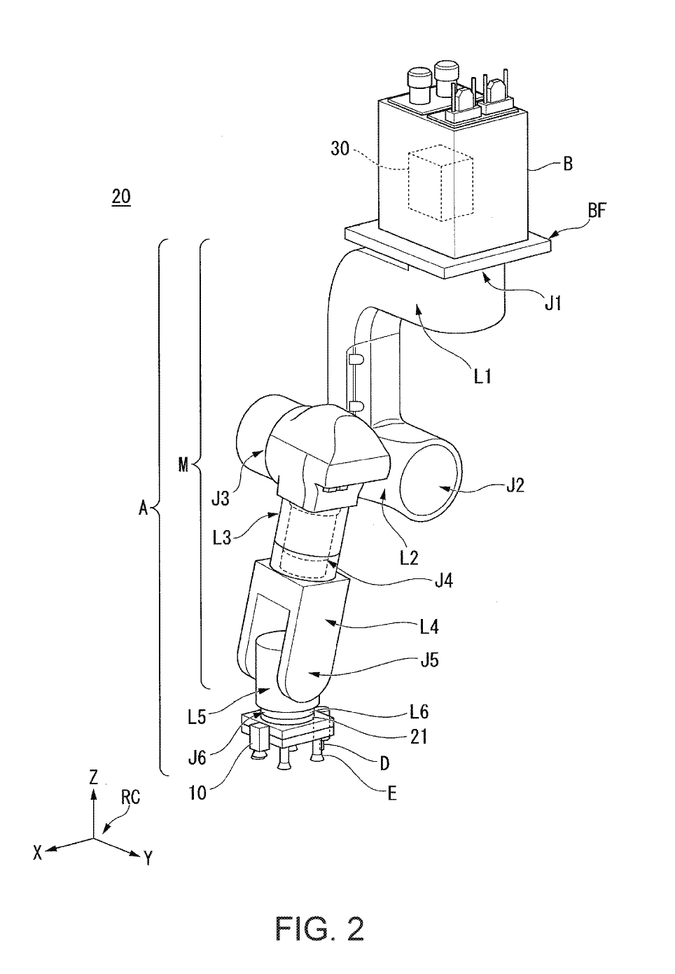

Firstly, a configuration of the robotic system 1 will be described with reference to FIG. 1 through FIG. 4. FIG. 1 is a diagram showing an example of the configuration of the robotic system 1 according to the embodiment of the invention. FIG. 2 is a diagram showing an example of a configuration of a robot 20.

The robotic system 1 is provided with, for example, a cradle BS and the robot 20. It should be noted that it is possible for the robotic system 1 to have a configuration provided with other devices such as a conveying device (e.g., another robot for conveying, or a belt conveyor) for conveying an object, an imaging section (i.e., a camera separated from the robot 20), and so on in addition thereto.

Hereinafter, for the sake of convenience of explanation, the description is presented referring to the gravitational direction (the vertically downward direction) as a downward direction or a lower side, and a direction opposite to the downward direction as an upward direction or an upper side. Hereinafter, as an example, there will be described the case in which the downward direction coincides with the negative direction of the Z axis in a robot coordinate system RC of the robot 20. It should be noted that it is also possible to adopt a configuration in which the downward direction does not coincide with the negative direction.

The cradle BS is, for example, a frame made of metal having a rectangular parallelepiped shape. It should be noted that the shape of the cradle BS can also be other shapes such as a columnar shape instead of the rectangular parallelepiped shape. Further, the material of the cradle BS can also be other materials such as resin instead of metal. The uppermost part, which is an end part located on the uppermost side out of the end parts provided to the cradle BS, is provided with a flat plate as a ceiling plate. The lowermost part, which is an end part located on the lowermost side out of the end parts provided to the cradle BS, is provided with a flat plate as a floor plate. Further, the cradle BS is disposed on an installation surface. The installation surface is, for example, a floor surface. It should be noted that the installation surface can also be other surfaces such as a wall surface, a ground surface, or a ceiling surface instead of the floor surface. In the robotic system 1, the robot 20 is installed on the ceiling plate of the cradle BS so that the predetermined operation can be performed inside the cradle BS. It should be noted that it is possible for the robotic system 1 to have a configuration which is not provided with the cradle BS. In this case, the robot 20 is installed on the floor surface, the wall surface, or the like instead of the cradle BS.

The robot 20 is a single arm robot provided with a base B, a movable part A supported by the base B, and a robot control device 30. The single arm robot is a robot provided with a single arm such as the movable part A in this example. It should be noted that the robot 20 can also be a duplex arm robot instead of the single arm robot. The duplex arm robot is a robot provided with two or more arms (e.g., two or more movable parts A). It should be noted that out of the duplex arm robots, a robot provided with two arms is also referred to as a dual-arm robot. In other words, the robot 20 can also be a dual-arm robot provided with two arms, or can also be a duplex arm robot provided with three or more arms (e.g., three or more movable parts A). Further, the robot 20 can also be other robots such as a scalar robot (a horizontal articulated robot), a Cartesian coordinate robot, or a cylindrical robot. The Cartesian coordinate robot is, for example, a gantry robot.

The shape of the base B is, for example, a roughly rectangular parallelepiped shape having the longitudinal direction along the vertical direction. The base B is made hollow. One of the surfaces provided to the base B is provided with a flange BF. Further, the flange BF is provided with the movable part A. In other words, the base B supports the movable part A with the flange BF. It should be noted that the shape of the base B can also be other shapes such as a cubic shape, a columnar shape, or a polyhedron shape instead of such a shape providing the base B can support the movable part A with the shape.

Hereinafter, the description is presented referring to the surface provided with the flange BF out of the surfaces provided to the base B as an upper surface, a surface on the opposite side to the surface provided with the flange BF out of the surfaces provided to the base B as a lower surface for the sake of convenience of explanation. The base B is installed on the ceiling plate so that, for example, the direction from the lower surface of the base B toward the upper surface of the base B coincides with the downward direction, in other words, so that the entire work area of the robot 20 is located on the lower side of the ceiling plate. Specifically, for example, the ceiling plate is provided with an opening section not shown, which penetrates in the vertical direction, and through which the base B can be inserted. The opening section is smaller than the flange BF. It is possible for the user to install (attach) the base B to the ceiling plate by fixing the flange BF and the ceiling plate to each other with a plurality of bolts. In other words, each of the flange BF and the ceiling plate is provided with through holes through which the bolts are respectively inserted. It should be noted that it is possible to adopt a configuration in which the base B is installed at a different position of the cradle BS. Further, another method can be used as the method of fixing the flange BF and the ceiling plate to each other.

The movable part A is provided with a manipulator M, end effectors E, a force detection section 21, an imaging section 10, and a discharge section D.

The manipulator M is provided with six arms, namely a first arm L1 through a sixth arm L6, and six joints, namely joints J1 through J6. The base B and the first arm L1 are connected to each other by the joint J1. The first arm L1 and the second arm L2 are connected to each other by the joint J2. The second arm L2 and the third arm L3 are connected to each other by the joint J3. The third arm L3 and the fourth arm L4 are connected to each other by the joint J4. The fourth arm L4 and the fifth arm L5 are connected to each other by the joint J5. The fifth arm L5 and the sixth arm L6 are connected to each other by the joint J6. Therefore, the movable part A provided with the manipulator M is a six-axis vertical articulated arm. It should be noted that the movable part A can be provided with a configuration of operating with a degree of freedom equal to or lower than five axes, or can also be provided with a configuration of operating with a degree of freedom equal to or higher than seven axes.

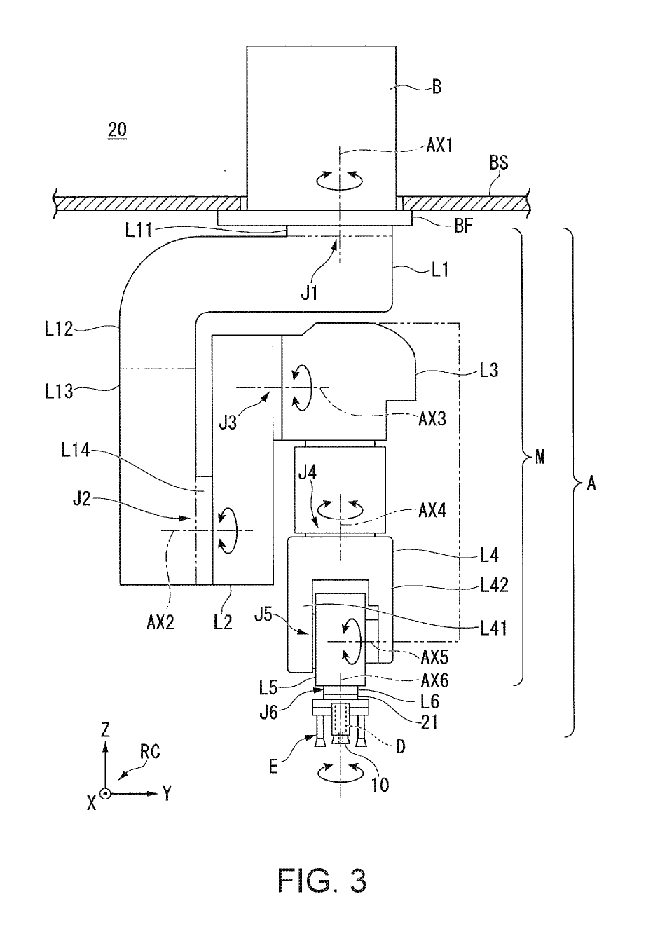

The first arm L1 can rotate around a first rotational axis AX1 (see, e.g., FIG. 3) which is the rotational axis of the joint J1. The second arm L2 can rotate around a second rotational axis AX2 (see, e.g., FIG. 3) which is the rotational axis of the joint J2. The third arm L3 can rotate around a third rotational axis AX3 (see, e.g., FIG. 3) which is the rotational axis of the joint J3. The fourth arm L4 can rotate around a fourth rotational axis AX4 (see, e.g., FIG. 3) which is the rotational axis of the joint J4. The fifth arm L5 can rotate around a fifth rotational axis AX5 (see, e.g., FIG. 3) which is the rotational axis of the joint J5. The sixth arm L6 can rotate around a sixth rotational axis AX6 (see, e.g., FIG. 3) which is the rotational axis of the joint J6.

Here, the manipulator M will be described in more detail with reference to FIG. 3 through FIG. 5. FIG. 3 is a diagram showing an example of a side view of the robot 20 shown in FIG. 1 and FIG. 2.

As shown in FIG. 3, since the direction from the lower surface of the base B toward the upper surface of the base B coincides with the downward direction, the joint J2 is located on the lower side of the joint J1. The joint J2 is not located on an extension of the first rotational axis AX1. This is because the shape of the first arm L1 is a curved shape. In this example, in the case of viewing the robot 20 from the positive direction of the X axis in the robot coordinate system RC toward the negative direction, the shape of the first arm L1 is a shape curved to be a rounded roughly L-shape. Specifically, the first arm L1 is constituted by four regions, namely regions L11 through L14. In FIG. 3, the region L11 denotes the region extending from the base B toward the downward direction along the first rotational axis AX1 out of the four regions constituting the first arm L1. The region L12 denotes the region extending from the lower end of the region 11 in the negative direction of the Y axis in the robot coordinate system RC along the second rotational axis AX2 out of the four regions. The region L13 denotes the region extending from the end part on the opposite side to the region L11 out of the end parts of the region L12 in the downward direction along the first rotational axis AX1 out of the four regions. The region L14 denotes the region extending from the end part on the opposite side to the region L12 out of the end parts of the region L13 in the positive direction of the Y axis along the second rotational axis AX2 out of the four regions. Here, the regions L11 through L14 can constitute the first arm L1 as a unit, or can constitute the first arm L1 as separate bodies. Further, in FIG. 3, the region L12 and the region L13 are roughly perpendicular to each other in the case of viewing the robot 20 along the X axis in the robot coordinate system RC.

The shape of the second arm L2 is an elongated shape. The second arm L2 is connected to the tip part of the first arm L1, namely the end part on the opposite side to the region L13 out of the end parts of the region L14.

The shape of the third arm L3 is an elongated shape. The third arm L3 is connected to the end part on the opposite side of the end part connected to the first arm L1 out of the end parts of the second arm L2.

The fourth arm L4 is connected to the tip part of the third arm L3, namely the end part on the opposite side of the end part connected to the second arm L2 out of the end parts of the third arm L3. The fourth arm L4 is provided with a support part L41 and a support part L42 as a pair of support parts opposite to each other. The support part L41 and the support part L42 are used for connection between the fourth arm L4 and the fifth arm L5. Specifically, the fourth arm L4 is connected to the fifth arm L5 with the support part L41 and the support arm L42 while positioning the fifth arm L5 between the support part L41 and the support part L42. It should be noted that the configuration of the fourth arm L4 is not limited thereto, but can also be a configuration (a cantilever) of supporting the fifth arm L5 with a single support part, or can also be a configuration of supporting the fifth arm L5 with three or more support parts.

As described above, the fifth arm L5 is located between the support part L41 and the support part L42, and is connected to the support part L41 and the support part L42.

The shape of the sixth arm L6 is a plate-like shape. In other words, the sixth arm L6 is a flange. The sixth arm L6 is connected to the end part on the opposite side to the forth arm L4 out of the end parts of the fifth arm L5. Further, the end effectors E are connected to the sixth arm L6 in the end part via the force detection section 21. Specifically, the force detection section 21 is disposed between the sixth arm L6 and the end effectors E.

Further, in this example. the second rotational axis AX2 and the third rotational axis AX3 out of the respective rotational axes of the six joints provided to the manipulator M are parallel to each other. It should be noted that the second rotational axis AX2 and the third rotational axis AX3 can also be nonparallel to each other.

Further, in this example, the axial directions of the respective rotational axes of the six joints provided to the manipulator M are different from each other. It should be noted that in the present embodiment, the fact that the respective axial directions of the two joints are different from each other represents that one of the axial directions and the other thereof do not coincide with each other (do not overlap each other). Therefore, in the present embodiment, in the case in which the rotational axes of the two joints do not overlap each other even though these rotational axes are parallel to each other, it is described that the axial directions of the two joints are different from each other.

It should be noted that in each of FIG. 1 through FIG. 3, the constituents such as an actuator, an encoder, a reduction mechanism, and a brake provided to each of the joints J1 through J6 are omitted in order to simplify the drawings. The brake can be an electromagnetic brake, or can also be a mechanical brake. Further, a part or the whole of the joints J1 through J6 can also be provided with a configuration not provided with the reduction mechanism. Further, a part or the whole of the joints J1 through J6 can also be provided with a configuration not provided with the brake.

Here, in the manipulator M, it is possible for the first arm L1 and the second arm L2 to overlap each other viewed from the axial direction of the first rotational axis AX1. Further, in the manipulator M, it is possible for the first arm L1 and the second arm L2 to overlap each other viewed from the axial direction of the second rotational axis AX2. Further, in the manipulator M, it is possible for the second arm L2 and the third arm L3 to overlap each other viewed from the axial direction of the second rotational axis AX2. Further, in the manipulator M, it is possible for the fourth arm L4 and the fifth arm L5 to overlap each other viewed from the axial direction of the fourth rotational axis AX4. It should be noted that in the present embodiment, the fact that certain two arms overlap each other in the case of viewing the two arms from a certain direction represents that the proportion of the area in which one of the two arms overlaps the other thereof is equal to or higher than a predetermined proportion. The predetermined proportion is, for example, nine out of ten, but is not limited thereto, and can also be another proportion. Further, the manipulator M can also be configured so that the third arm L3 and the fourth arm L4 can overlap each other viewed from the axial direction of the third rotational axis AX3. Further, the manipulator M can also be configured so that the fifth arm L5 and the sixth arm L6 can overlap each other viewed from the axial direction of the fifth rotational axis AX5.

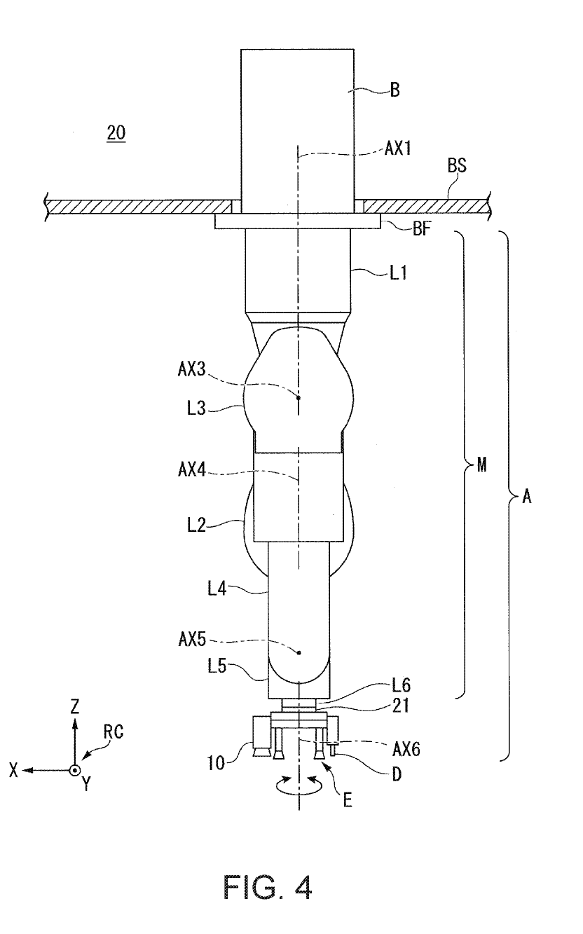

Here, in the manipulator M, the state of the manipulator M can be set to a compact state by rotating each of the joint J2 and the joint J3. In this example, the compact state denotes the state in which the distance between the second rotational axis AX2 and the fifth rotational axis AX5 in the direction along the first rotational axis AX1 is the shortest, and the first rotational axis AX1 and the fourth rotational axis AX4 coincide with each other. In other words, the state of the manipulator M shown in FIG. 3 is the compact state. In the case of viewing the robot 20 shown in FIG. 3 from the positive direction of the Y axis in the robot coordinate system RC toward the negative direction of the Y axis, in the manipulator M in the compact state, the three arms, namely the first arm L1, the second arm L2, and the third arm L3, overlap each other as shown in FIG. 4. FIG. 4 shows an example of a front view of the robot 20 in the case of viewing the robot 20 shown in FIG. 3 from the positive direction of the Y axis in the robot coordinate system RC toward the negative direction of the Y axis.

The reason that the state of the manipulator M can be set to the compact state is that the second arm L2 is formed to have a shape and a size not interfering with each of the ceiling plate of the cradle BS and the first arm L1 due to the rotation of the joint J2.

Here, in this example, in the case in which the state of the manipulator M is the compact state, the length of the first arm L1 is longer than the length of the second arm L2 in the direction along the first rotational axis AX1. Further, in this case, in this direction, the length of the second arm L2 is longer than the length of the third arm L3. Further, in this case, in this direction, the length of the fourth arm L4 is longer than the length of the fifth arm L5. Further, in this case, in this direction, the length of the fifth arm L5 is longer than the length of the sixth arm L6. It should be noted that the length of each of the first arm L1 through the sixth arm L6 can also be another length instead thereof.

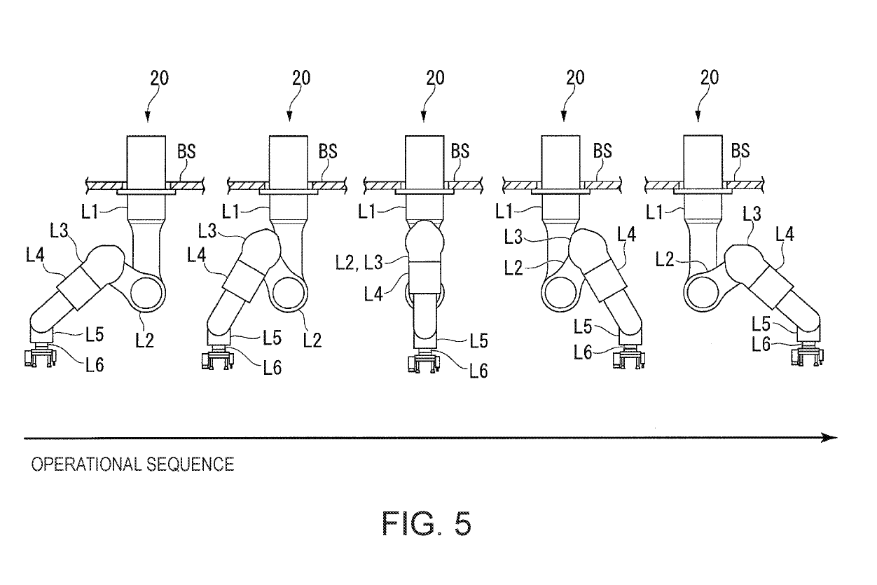

Further, since the state of the manipulator M can be set to the compact state, it is possible for the manipulator M to move the position of the joint J6 to a position different as much as 180° around the first rotational axis AX1 via the compact state by rotating the joint J2 without rotating the joint J1 as shown in FIG. 5. FIG. 5 is a diagram for explaining an operation going through the compact state out of the operations of the manipulator M. The position of the joint 6 is represented by the position of the centroid of the joint J6 in this example. It should be noted that it is also possible to adopt a configuration in which the position of the joint J6 is represented by another position associated with the joint J6 instead of the position of the centroid of the joint J6. More specifically, it is possible for the manipulator M to move the sixth arm L6 as the tip of the manipulator M from the left side position shown in the left side of FIG. 5 to the right side position shown in the right side of FIG. 5 different as much as 180° around the first rotational axis AX1 via the compact state by rotating the joint J2 without rotating the joint J1. It should be noted that in the operation shown in FIG. 5, in the case of viewing the robot 20 from the direction along the first rotational axis AX1, the sixth arm L6 moves on a straight line.

Further, the total length of the third arm L3 through the sixth arm L6 is longer than the length of the second arm L2. Thus, if the state of the manipulator M is made to coincide with the compact state in the case of viewing the robot 20 from a direction along the second rotational axis AX2, it is possible to make the tip of the sixth arm L6 project from the second arm L2. As a result, in the case of attaching the end effectors E to the sixth arm L6, it is possible to prevent the end effectors E from interfering with the first arm L1 and the second arm L2.

As described above, it is possible for the manipulator M to move the end effectors E to a position different as much as 180⁰ around the first rotational axis AX1 via the compact state by making the rotation around the second rotational axis AX2 without making the rotation around the first rotational axis AX1. As a result, the robot 20 can efficiently move the end effectors E, and at the same time, it is possible to reduce the space provided for preventing a part of the robot 20 from interfering with other objects.

Going back to FIG. 2, the actuators provided to the respective joints J1 through J6 provided to the manipulator Mare each connected to the robot control device 30 with a cable so as to be able to communicate with the robot control device 30. Thus, the actuator operates the manipulator M based on the control signal obtained from the robot control device 30. It should be noted that wired communication via the cable is performed conforming with the standard such as Ethernet (registered trademark) or USB (universal serial bus). Further, some or all of the actuators can be provided with a configuration of being connected to the robot control device 30 with wireless communication performed conforming with the communication standard such as Wi-Fi (registered trademark).

The end effectors E are each an end effector provided with a suction part capable of suctioning (holding) an object with air. The end effectors E are each an example of a holding part. It should be noted that the end effector E can also be another end effector such as an end effector provided with a claw part (a finger part) capable of grasping an object instead of the end effector provided with the suction part.

The end effector E is connected so as to be able to communicate with the robot control device 30 with the cable. Thus, the end effectors E each perform the operation based on the control signal obtained from the robot control device 30. It should be noted that the wired communication via the cable is performed conforming with the standard such as Ethernet (registered trademark) or USB. Further, the end effectors E can also be provided with a configuration of being connected to the robot control device 30 with the wireless communication performed conforming with the communication standard such as Wi-Fi (registered trademark).

The force detection section 21 is disposed between the end effectors E and the manipulator M. The force detection section 21 is, for example, a force sensor. The force detection section 21 detects external force having acted on the end effector E or an object suctioned by the end effector E. The external force includes translational force for translating the end effector E or the object suctioned by the end effector E, and a rotational moment (torque) for rotating the end effector E or the object grasped by the end effector E. The force detection section 21 outputs the force detection information including the value representing the magnitude of the external force detected as an output value to the robot control device 30 using the communication.

The force detection information is used for the force control, which is the control based on the force detection information out of the control of the robot 20 due to the robot control device 30. The force control is the control for operating at least one of the end effector E and the manipulator M so as to realize the state in which the external force represented by the force detection information satisfies a predetermined termination condition. The termination condition is the condition for the robot control device 30 to terminate the operation of the robot 20 due to the force control. In other words, the force control denotes compliant motion control such as impedance control. It should be noted that the force detection section 21 can also be another sensor for detecting a value representing the magnitude of the force or the moment applied to the end effectors E or the object suctioned by the end effectors E such as a torque sensor. Further, instead of the configuration in which the force detection section 21 is provided between the end effectors E and the manipulator M, it is also possible to adopt a configuration in which the force detection section 21 is provided to another region of the manipulator M.

The force detection section 21 is connected so as to be able to communicate with the robot control device 30 with the cable. The wired communication via the cable is performed conforming with the standard such as Ethernet (registered trademark) or USB. It should be noted that it is also possible to adopt a configuration in which the force detection section 21 and the robot control device 30 are connected to each other with the wireless communication performed conforming with the communication standard such as Wi-Fi (registered trademark).

Since the force detection section 21 is provided to the robot 20, it is possible for the user to teach (store) an operation of the robot 20 to the robot control device 30 with direct teaching when teaching the operation of the robot 20 to the robot control device 30. Further, since the robot 20 is provided with the force detection section 21, it is possible for the robot control device 30 to, for example, make the robot 20 hold an object without deforming the object using the force control.

The imaging section 10 is, for example, a camera provided with an imaging element for converting the light collected into an electric signal such as a charge coupled device (CCD) or a complementary metal oxide semiconductor (CMOS). In this example, the imaging section 10 is provided to a part of the end effectors E. Therefore, the imaging section 10 moves in accordance with the motion of the movable part A. Further, the range which the imaging section 10 can image varies in accordance with the motion of the movable part A. The imaging section 10 can be provided with a configuration of taking a still image of the range, or can also be provided with a configuration of taking a moving image of the range.

The imaging section 10 is connected so as to be able to communicate with the robot control device 30 with the cable. The wired communication via the cable is performed conforming with the standard such as Ethernet (registered trademark) or USB. It should be noted that the imaging section 10 can also be provided with a configuration of being connected to the robot control device 30 with the wireless communication performed conforming with the communication standard such as Wi-Fi (registered trademark).

The discharge section D is a dispenser capable of discharging a discharge object. The discharge object denotes a substance which can be discharged such as a liquid, a gas, or a powder or granular material. The case in which the discharge object is grease (a lubricant material) will hereinafter be described as an example. The discharge section D is provided with a syringe section not shown, a needle section not shown, and an air injection section nor shown for injecting the air inside the syringe section. The syringe section is a container having a space for containing the grease inside. The needle section has a needle for discharging the grease contained in the syringe section. The needle section discharges the grease from the tip of the needle. In other words, in the discharge section D, by the air injection section injecting the air inside the syringe section, the grease contained inside the syringe section is discharged from the tip of the needle section. In this example, the discharge section D is provided to a part of the end effectors E. Therefore, the position where the discharge section D can discharge the discharge object varies in accordance with the motion of the movable part A.

The robot control device 30 is a controller for controlling the robot 20. The robot control device 30 operates the robot 20 based on an operation program stored in advance by the user. Thus, it is possible for the robot control device 30 to make the robot 20 perform a predetermined operation.

The robot control device 30 is provided inside (incorporated in) the base B in this example. It should be noted that the robot control device 30 can also be a separate body from the robot 20 instead thereof. In this case, the robotic system 1 is provided with at least the robot 20 and the robot control device 30 separated from the robot 20.

### Outline of Process Performed by Robot Control Device When Operating Robot

The outline of the process performed by the robot control device 30 when operating the robot 20 will hereinafter be described.

The robot control device 30 sets a control point T, which is a tool center point (TCP) moving together with the discharge section D, to a predetermined position of the discharge section D. The predetermined position of the discharge section D is the position of the tip of the needle section provided to the discharge section D. It should be noted that the predetermined position of the discharge section D can also be another position associated with the discharge section D such as the position of the centroid of the discharge section D instead thereof. Further, it is also possible to provide the robot control device 30 with a configuration of setting the control point T at another position associated with the movable part A instead of the configuration of setting the control point T at the predetermined position of the discharge section D.

The robot control device 30 sets the control point T based on control point setting information input in advance from the user. The control point setting information is information representing relative position and posture from the position and posture of, for example, a P-point (an output point of the robot 20) to the position and posture of the tip of the needle section provided to the discharge section D. The P-point denotes an imaginary point representing the position and the posture of the movable part A (i.e., the robot 20), and is the point, the position and the posture of which can be calculated based on the rotational angles of the respective joints J1 through J6. Hereinafter, the case in which the P-point is an imaginary point moving together with the centroid of the joint J6 will be described. In other words, in this example, the position of the P-point is represented by the position in the robot coordinate system RC of the origin of a P-point coordinate system PC as the three-dimensional local coordinate system associated with the centroid. Further, the posture of the P-point is represented by the direction in the robot coordinate system RC of each of the coordinate axes in the P-point coordinate system PC. In this case, the relative position and posture between the P-point and the control point T does not vary even if the robot 20 operates in any manner except an error due to a vibration or the like. It is possible for the robot control device 30 to calculate the position and the posture of the P-point using the direct kinematics based on the present rotational angles of the respective joints J1 through J6. As a result, it is possible for the robot control device 30 to calculate the position and the posture of the control point T based on the position and the posture of the P-point thus calculated and the control point setting information. It should be noted that the P-point can also be an imaginary point moving together with another region associated with the movable part A instead of the imaginary point moving together with the centroid of the joint J6.

Control point position information as information representing the position of the control point T and control point posture information as information representing the posture of the control point T are associated with the control point T. It should be noted that it is also possible to adopt a configuration in which other information is associated with the control point T in addition thereto. The robot control device 30 designates (determines) each of the control point position information and the control point posture information. The robot control device 30 operates at least one of the joints J1 through J6 to move the P-point to make the position of the control point T coincide with the position represented by the control point position information thus designated, and at the same time, make the posture of the control point T coincide with the posture represented by the control point posture information thus designated. In other words, the robot control device 30 designates the control point position information and the control point posture information to thereby operate the robot 20.

In this example, since the robot 20 is provided with the movable part A of the six-axis vertical articulated type, the position of the control point T is roughly determined by rotating each of the joints J1 through J3. It should be noted that the position of the control point T can also be fine adjusted by rotating each of the joints J4 through J6 . Further, in the example, the posture of the control point T is determined by rotating each of the joints J4 through J6.

In this example, the position of the control point T is represented by the position in the robot coordinate system RC of the origin of a control point coordinate system TC. Further, the posture of the control point T is represented by the direction in the robot coordinate system RC of each of the coordinate axes of the control point coordinate system TC. The control point coordinate system TC is a three-dimensional local coordinate system associated with the control point T so as to move together with the control point T. It should be noted that in this example, the position and the posture of the tip of the needle section provided to the discharge section D are represented by the position and the posture of the control point T.

Further, the robot control device 30 moves the control point T based on teaching point information stored in advance in the robot control device 30.

The teaching point information is information representing a teaching point. The teaching point denotes an imaginary point to be a target for moving the control point T when the robot control device 30 operates the manipulator M. Teaching point position information, teaching point posture information, teaching point velocity information, and teaching point identification information are associated with the teaching point. The teaching point position information is information representing the position of the teaching point. Further, the teaching point posture information is information representing the posture of the teaching point. The teaching point velocity information is information representing the velocity of the teaching point. The teaching point identification information is information for identifying the teaching point. Further, the teaching point identification information is also information representing the order of the teaching point. In this example, the position of the teaching point is represented by the position in the robot coordinate system RC of the origin of the teaching point coordinate system as the three-dimensional local coordinate system associated with the teaching point. Further, the posture of the teaching point is represented by the direction in the robot coordinate system RC of each of the coordinate axes of the teaching point coordinate system.

The robot control device 30 designates one or more teaching points represented by the teaching point information in sequence based on the operation program input in advance by the user. Then, the robot control device 30 generates (calculates) a trajectory from the first teaching point, which is the teaching point coinciding with the present control point T, to the second teaching point, which is the teaching point thus designated based on the operation program. The trajectory can be a straight line, or can also be a curved line. The case in which the trajectory is a straight line will hereinafter be described as an example. It should be noted that the first teaching point includes a starting point with which the robot 20 first makes the control point T coincide.

Further, the robot control device 30 performs the continuous path (CP) control based on the operation program input in advance by the user. In the continuous path control, the robot control device 30 generates (calculates) the trajectory from the first teaching point to the second teaching point, and representing the change in position and posture of the control point T as a function of the elapsed time when the control point T moves from the first teaching point to the second teaching point. In other words, by designating the elapsed time, it is possible for the robot control device 30 to identify the position and the posture of the control point T on the trajectory based on the trajectory. Hereinafter, the description will be presented referring to the trajectory as a continuous path trajectory (a CP trajectory) for the sake of convenience of explanation. Here, when generating the continuous path trajectory, the robot control device 30 generates the continuous path trajectory in the case in which the velocity of the control point T moving along the continuous path trajectory is the velocity at the second teaching point. Then, the robot control device 30 moves the control point T from the first teaching point to the second teaching point along the continuous path trajectory thus generated. On this occasion, the robot control device 30 measures the elapsed time from the timing at which the control point T is started to move from the first teaching point, and identifies the position and the posture of the control point T corresponding to the elapsed time thus measured and on the continuous path trajectory as a target position and a target posture, respectively. The robot control device 30 designates the information representing the target position thus identified as the control point position information, and designates the information representing the target posture thus identified as the control point posture information. The target position and the target posture denote the position and the posture to be the target with which the robot control device 30 makes the position and the posture of the control point T coincide. Thus, the robot control device 30 makes the position and the posture of the control point T coincide with the target position and the target posture. In such a manner, it is possible for the robot control device 30 to move the control point T in accordance with the elapsed time described above until the control point T coincides with the second teaching point. It should be noted that regarding the method of generating the continuous path trajectory using the continuous path control, it is possible to use a known method, or it is also possible to use a method newly developed in the future, and therefore, the description will be omitted.

When the robot control device 30 moves the control point T along the continuous path trajectory in the continuous path control, the robot control device 30 calculates the rotational angles of the respective joints J1 through J6 in the case in which the position and the posture of the control point T coincide with the target position and the target posture as first rotational angles based on the inverse kinematics. For example, in the case in which the position and the posture of the present control point T coincide with the position and posture X1, and the target position and the target posture are the position and posture X2, the robot control device 30 calculates the rotational angles of the respective joints J1 through J6 in the case in which the position and the posture of the control point T coincide with the position and posture X2 as the first rotational angles based on the inverse kinematics. The robot control device 30 makes each of the joints J1 through J6 perform the continuous path operation based on the first rotational angles thus calculated to thereby make the position and the posture of the control point T coincide with the target position and the target posture. The continuous path operation, which a certain joint is made to perform, denotes an operation of making the rotational angle of the joint coincide with the rotational angle of the joint included in the first rotational angles. For example, the continuous path operation, which a joint JN is made to perform, denotes an operation of making the rotational angle of the joint JN coincide with the rotational angle of the joint JN included in the first rotational angles. Here, N denotes either one of the integers of 1 through 6. By making each of the joints J1 through J6 repeat such a continuous path operation, the robot control device 30 moves the control point T from the first teaching point to the second teaching point.

Here, in the case in which the posture of the robot 20 approximates to a singular configuration in the continuous path operation, at least one of the joints provided to the robot 20 rotates at a velocity (i.e., a rotational velocity or an angular velocity) exceeding a limit velocity in some cases. There is a possibility that a failure occurs in the joint continuing to rotate at the velocity exceeding the limit velocity. Therefore, in such a case, the robot 20 determines that an error occurs, and performs a variety of operations corresponding to the occurrence of the error such as stoppage of the operation. However, in the case in which the robot 20 performs such an operation, the predetermined operation which the robot control device 30 has made the robot 20 perform is interrupted, and thus the efficiency of the operation is degraded in some cases.

The singular configuration denotes the posture of the robot in the case in which the P-point of the robot coincides with a singular point. The singular point denotes an imaginary point making the solution in the inverse kinematics indefinite due to a decrease or an increase in degree of freedom of the robot 20 caused by the P-point coinciding with the imaginary point. The position at which the P-point is defined (set) to the robot 20 differs by the structure of the robot 20. Therefore, the singular configuration is a posture differs in accordance with the structure of the robot 20. In this example, the posture of the robot 20 is represented by a combination of the rotational angles of the respective joints J1 through J6 of the robot 20.

In order to prevent such a problem from occurring, the robot control device 30 in this example displays an area in which the control point T can move so that the P-point of the robot 20 does not pass through the singular point. Thus, it is possible for the robot control device 30 to help the user to determine the work area of the robot 20. Specifically, it is possible for the user to refer to the area displayed by the robot control device 30 to determine the work area of the robot 20 within the area in which the control point T can move so that the P-point of the robot 20 does not pass through the singular point. It should be noted that in the robotic system 1, it is also possible to adopt a configuration in which the P-point and the control point T are set at the same position.

An area display process of the robot control device 30 for displaying the area in which the control point T can move so that the P-point of the robot 20 does not pass through the singular point, and a process of the robot control device 30 for making the robot 20 perform a predetermined operation are hereinafter described in detail.

### Outline of Predetermined Operation Which Robot Control Device Makes Robot Perform

The predetermined operation which the robot control device 30 makes the robot 20 perform will hereinafter be described.

In this example, the predetermined operation includes two operations, namely a first operation and a second operation. The first operation is an operation of discharging (i.e., applying) the grease on an upper surface of an object O disposed on an upper surface of a workbench TB having a plate-like shape disposed inside the cradle BS. The second operation is an operation of discharging (i.e., applying) the grease on a side surface of an object G disposed on the upper surface of the workbench TB. It should be noted that the predetermined operation can also be another operation instead thereof. Further, the predetermined operation can also be either one of the first operation and the second operation.

The object O is an industrial component or member to be assembled to a product. The case in which the object O is a plate having a plate-like shape to be assembled to a product will hereinafter be described as an example. It should be noted that the object O can also be another object such as daily necessities or living body instead of the industrial component or member. Further, the shape of the object O can also be another shape such as a disk-like shape, a rectangular parallelepiped shape, or a columnar shape instead of the plate-like shape.

The object G is an industrial component or member to be assembled to a product, and is a component or a member different from the object O. The case in which the object G is a gear wheel to be assembled to the product will hereinafter be described as an example. It should be noted that the object G can also be another object such as daily necessities or living body instead of the industrial component or member. In FIG. 1, the object G as the gear wheel is displayed as an object having a columnar shape in order to simplify the drawing. Here, the case in which the side surface of the object G disposed on the upper surface of the workbench TB is a surface provided with teeth of the gear wheel arranged will hereinafter be described as an example.

### Hardware Configuration of Robot Control Device

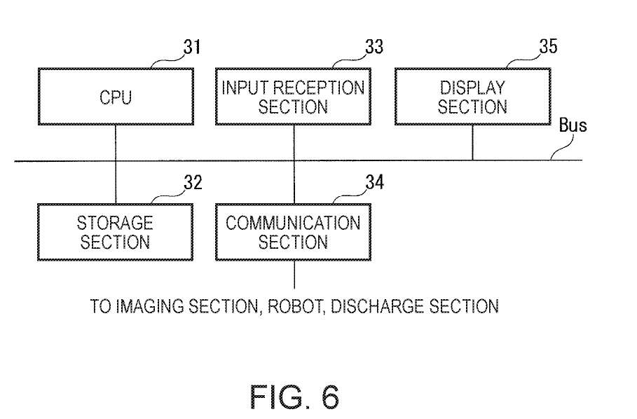

The hardware configuration of the robot control device 30 will hereinafter be described with reference to FIG. 6. FIG. 6 is a diagram showing an example of the hardware configuration of the robot control device 30.

The robot control device 30 is provided with, for example, a central processing unit (CPU) 31 being one example of a processor, a storage section 32, an input reception section 33, a communication section 34, and a display section 35. These constituents are connected via a bus Bus so as to be able to communicate with each other. Further, the robot control device 30 communicates with each of the imaging section 10, the robot 20, and the discharge section D via the communication section 34.

The CPU 31 executes a variety of programs stored in the storage section 32.

The storage section 32 includes, for example, a hard disk drive (HDD), a solid state drive (SSD), an electrically erasable programmable read-only memory (EEPROM), a read-only memory (ROM), and a random access memory (RAM). Those are examples of a memory for storing computer-executable instructions. It should be noted that the storage section 32 can also be an external storage device connected using a digital input-output port such as the USB instead of those built into the robot control device 30. The storage section 32 stores a variety of types of information (including the teaching point information), a variety of types of programs (including the operation program), a variety of types of images and so on processed by the robot control device 30.

The input reception section 33 is an input device such as a keyboard, a mouse, or a touch pad. It should be noted that the input reception section 33 can also be a touch panel configured integrally with the display section 35 instead thereof. Further, the input reception section 33 can also be a separate body from the robot control device 30. In this case, the input reception section 33 is connected so as to be able to communicate with the robot control device 30 with wire or wirelessly.

The communication section 34 is configured including, for example, a digital input-output port such as the USB, or an Ethernet (registered trademark) port.

The display section 35 is, for example, a liquid crystal display panel, or an organic electroluminescence (EL) display panel. Those are examples of a display. It should be noted that the display section 35 can also be a separate body from the robot control device 30. In this case, the display section 35 is connected so as to be able to communicate with the robot control device 30 with wire or wirelessly.

### Functional Configuration of Robot Control Device

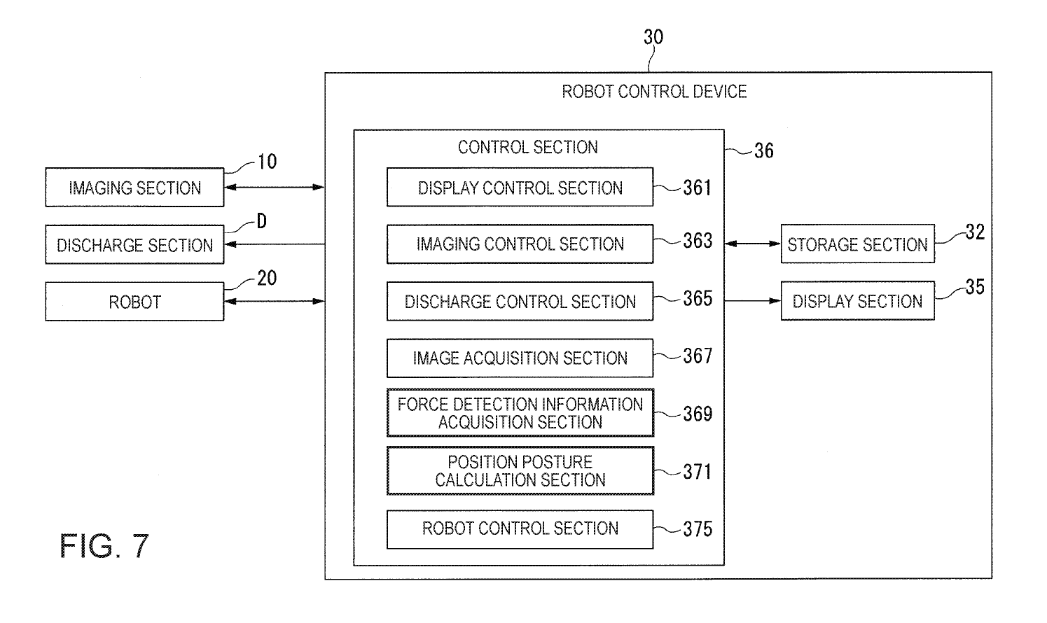

The functional configuration of the robot control device 30 will hereinafter be described with reference to FIG. 7. FIG. 7 is a diagram showing an example of the functional configuration of the robot control device 30.

The robot control device 30 is provided with the storage section 32, the display section 35, and a control section 36.

The control section 36 controls the whole of the robot control device 30. The control section 36 is provided with a display control section 361, an imaging control section 363, a discharge control section 365, an image acquisition section 367, a force detection information acquisition section 369, a position posture calculation section 371, and a robot control section 375. These functional sections provided to the control section 36 are realized by, for example, the CPU 31 executing a variety of types of programs stored in the storage section 32. Further, some or all of the functional sections can also be a hardware functional section such as a large scale integration (LSI), or an application specific integrated circuit (ASIC).

The display control section 361 generates a variety of types of images, which the robot control device 30 makes the display section 35 display. The display control section 361 makes the display section 35 display the image thus generated.

The imaging control section 363 makes the imaging section 10 take an image of the range which can be imaged by the imaging section 10.

The discharge control section 365 makes the discharge section D discharge the discharge object to the position where the discharge section D can discharge the discharge object in accordance with a request from the robot control section 375.

The image acquisition section 367 obtains the taken image, which has been taken by the imaging section 10, from the imaging section 10.

The force detection information acquisition section 369 obtains the force detection information, which includes the value representing the magnitude of the external force detected by the force detection section 21 as an output value, from the force detection section 21.

The position posture calculation section 371 calculates the position and the posture of an object included in the taken image based on the taken image obtained by the image acquisition section 367.

The robot control section 375 retrieves teaching point first information, which is the teaching point information used for the first operation out of the teaching point information stored in advance in the storage section 32, from the storage section 32. Further, the robot control section 375 obtains the information representing the rotational angles of the respective joints J1 through J6 from the robot 20, and then calculates the position and the posture of the present control point T as the position and the posture of the first teaching point using the direct kinematics based on the information thus obtained. The robot control section 375 generates the continuous path trajectory based on the first teaching point thus calculated, and each of one or more second teaching points represented by the teaching point first information retrieved from the storage section 32. The robot control section 375 makes the robot 20 perform the first operation based on the continuous path trajectory thus generated.

Further, the robot control section 375 retrieves teaching point second information, which is the teaching point information used for the second operation out of the teaching point information stored in advance in the storage section 32, from the storage section 32. The robot control section 375 makes the robot 20 perform the second operation based on the teaching point second information thus retrieved.

It should be noted that when operating the robot 20, the robot control section 375 can perform the control based on the force detection information obtained by the force detection information acquisition section 369, but is not required to perform the control based on the force detection information obtained by the force detection information acquisition section 369.

### Area Display Process Performed By Robot Control Device

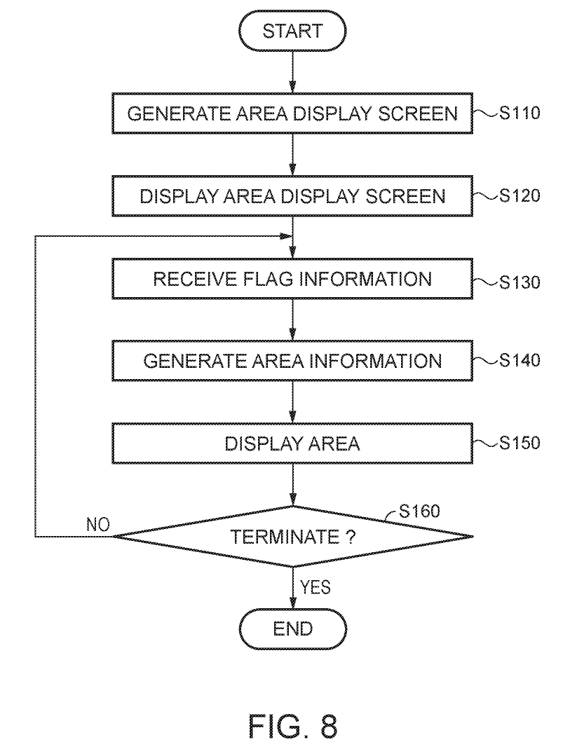

The area display process performed by the robot control device 30 will hereinafter be described with reference to FIG. 8. FIG. 8 is a flowchart showing an example of a flow of the area display process performed by the robot control device 30. It should be noted that in the flowchart shown in FIG. 8, the case in which the robot control device 30 has received in advance the operation of starting the area display process from the user before the process of the step S110 is performed will be described.

The display control section 361 generates the area display screen (step S110). The area display screen is a screen for the robot control device 30 to receive a variety of operations from the user in the area display process. Then, the display control section 361 makes (step S120) the display section 35 display the area display screen generated in the step S110.

Then, the robot control section 375 waits (step S130) until the flag information is received from the area display screen displayed on the display section 35 in the step S120. Here, the process of step S130 will be described.

The flag information is the information representing each of three flags namely a first flag, a second flag, and a third flag.

The first flag is a flag for instructing the robot control section 375 which one of an 11-th operation and a 12-th operation the robot 20 is made to perform when the robot control section 375 operates the robot 20. In the case in which the first flag shows 0, the robot control section 375 makes the robot 20 perform the 11-th operation. In contrast, in the case in which the first flag shows 1, the robot control section 375 makes the robot 20 perform the 12-th operation. The 11-th operation denotes an operation of rotating at least one of the joints J1 through J6 so that the fifth rotational axis AX5 is always located on the right side of the first rotational axis AX1 or on the first rotational axis AX1 in the case of viewing the robot 20 toward the direction in which the second arm L2 and the first arm L1 appear side by side in this order along the second rotational axis AX2 out of the operations of the robot 20. The 12-th operation denotes an operation of rotating at least one of the joints J1 through J6 so that the fifth rotational axis AX5 is always located on the left side of the first rotational axis AX1 in the case described above out of the operations of the robot 20. It should be noted that the 11-th operation can also denote an operation of rotating at least one of the joints J1 through J6 so that the fifth rotational axis AX5 is always located on the right side of the first rotational axis AX1 in the case described above out of the operations of the robot 20. In this case, the 12-th operation denotes an operation of rotating at least one of the joints J1 through J6 so that the fifth rotational axis AX5 is always located on the left side of the first rotational axis AX1 or on the first rotational axis AX1 in the case of viewing the robot 20 toward the direction in which the second arm L2 and the first arm L1 appear side by side in this order along the second rotational axis AX2 out of the operations of the robot 20.

The second flag is a flag for instructing the robot control section 375 which one of a 21-st operation and a 22-nd operation the robot 20 is made to perform when the robot control section 375 operates the robot 20. In the case in which the second flag shows 0, the robot control section 375 makes the robot 20 perform the 21-st operation. In contrast, in the case in which the second flag shows 1, the robot control section 375 makes the robot 20 perform. the 22-nd operation. The 21-st operation denotes an operation of rotating at least one of the joints J1 through J6 so that the third rotational axis AX3 is always located on the upper side of the second rotational axis AX2 or the respective positions of the third rotational axis AX3 and the second rotational axis AX2 in the vertical direction are located at the same position in the case of viewing the robot 20 toward the direction in which the second arm L2 and the first arm L1 appear side by side in this order along the second rotational axis AX2 out of the operations of the robot 20. The 22-nd operation denotes an operation of rotating at least one of the joints J1 through J6 so that the third rotational axis AX3 is always located on the lower side of the second rotational axis AX2 in the case described above out of the operations of the robot 20. It should be noted that the 21-st operation can also denote an operation of rotating at least one of the joints J1 through J6 so that the third rotational axis AX3 is always located on the upper side of the second rotational axis AX2 in the case described above out of the operations of the robot 20. In this case, the 22-nd operation denotes an operation of rotating at least one of the joints J1 through J6 so that the third rotational axis AX3 is always located on the lower side of the second rotational axis AX2 or the respective positions of the third rotational axis AX3 and the second rotational axis AX2 in the vertical direction are located at the same position in the case of viewing the robot 20 toward the direction in which the second arm L2 and the first arm L1 appear side by side in this order along the second rotational axis AX2 out of the operations of the robot 20.

The third flag is a flag for instructing the robot control section 375 which one of a 31-st operation and a 32-nd operation the robot 20 is made to perform when the robot control section 375 operates the robot 20. In the case in which the third flag shows 0, the robot control section 375 makes the robot 20 perform the 31-st operation. In contrast, in the case in which the third flag shows 1, the robot control section 375 makes the robot 20 perform the 32-nd operation. The 31-st operation denotes an operation of rotating at least one of the joints J1 through J6 so that the centroid of the joint J6 is located at the position rotated clockwise around the fifth rotational axis AX5 from the fourth rotational axis AX4, or on the fourth rotational axis AX4 in the case of viewing the robot 20 toward the direction in which the second arm L2 and the first arm L1 appear side by side in this order along the second rotational axis AX2 out of the operations of the robot 20. The 32-nd operation denotes an operation of rotating at least one of the joints J1 through J6 so that the centroid is located at the position rotated counterclockwise around the fifth rotational axis AX5 from the fourth rotational axis AX4 in the case described above out of the operations of the robot 20. It should be noted that the 31-st operation can also denote an operation of rotating at least one of the joints J1 through J6 so that the centroid is located at the position rotated clockwise around the fifth rotational axis AX5 from the fourth rotational axis AX4 in the case described above out of the operations of the robot 20. In this case, the 32-nd operation denotes an operation of rotating at least one of the joints J1 through J6 so that the centroid is located at the position rotated counterclockwise around the fifth rotational axis AX5 from the fourth rotational axis AX4, or on the fourth rotational axis AX4 in the case of viewing the robot 20 toward the direction in which the second arm L2 and the first arm L1 appear side by side in this order along the second rotational axis AX2 out of the operations of the robot 20.

Here, the P-point of the robot 20 passes through the singular point on the boundary where the operation of the robot 20 makes the transition from the 11-th operation to the 12-th operation, or the boundary where the operation of the robot 20 makes the transition from the 12-th operation to the 11-th operation. Therefore, in the case in which the first flag is not set to the robot control section 375, the robot control section 375 moves the control point T so that the P-point passes through the singular point in some cases. Further, the P-point of the robot 20 passes through the singular point on the boundary where the operation of the robot 20 makes the transition from the 21-st operation to the 22-nd operation, or the boundary where the operation of the robot 20 makes the transition from the 22-nd operation to the 21-st operation. Therefore, in the case in which the second flag is not set to the robot control section 375, the robot control section 375 moves the control point T so that the P-point passes through the singular point in some cases . Further, the P-point of the robot 20 passes through the singular point on the boundary where the operation of the robot 20 makes the transition from the 31-st operation to the 32-nd operation, or the boundary where the operation of the robot 20 makes the transition from the 32-nd operation to the 31-st operation. Therefore, in the case in which the third flag is not set to the robot control section 375, the robot control section 375 moves the control point T so that the P-point passes through the singular point in some cases.

In order to prevent the P-point from passing through the singular point, the robot control section 375 receives the flag information from the user in the step S130. Then, the robot control section 375 sets each of the first through third flags represented by the flag information thus received to the robot control section 375. Thus, it is possible for the robot control section 375 to move the control point T so that the P-point does not pass through the singular point. In other words, in the case in which each of the first through third flags does not change from the predetermined flag state (i.e., either one of 0 and 1) (in the case in which each of the first through third flags is set to the robot control section 375), it is possible for the robot control section 375 to move the control point T so that the P-point does not pass through the singular point. In other words, the area in which the P-point (or the control point T) can move in the state in which each of the first through third flags is set to the robot control section 375 is the area in which the control point T can be moved so that the P-point does not pass through the singular point.

After the process of the step S130 is performed, the display control section 361 generates (step 5140) area information representing the area in which the robot control section 375 can move the P-point while keeping the state in which each of the first through third flags represented by the flag information received by the robot control section 375 in the step S130 is set to the robot control section 375. In other words, the area is an area corresponding to the first through third flags represented by the flag information. Here, the area is expressed as an area in the robot coordinate system RC.

Then, the display control section 361 makes (step S150) the display section 35 display the area represented by the area information generated in the step S140. Specifically, the display control section 361 generates a virtual space VS, which virtually shows the real space in which the robot 20 is installed, in the storage area of the storage section 32. Each position in the virtual space VS is expressed by a coordinate in the robot coordinate system RC. The display control section 361 disposes a robot VR1, which is a virtual robot 20, in the virtual space VS. Then, the display control section 361 disposes an area image VR2 representing the area so as to be superimposed on the virtual robot 20 disposed in the virtual space VS. On this occasion, the display control section 361 sets the transparency of the area image VR2 to a predetermined value to thereby dispose the area image VR2 in the virtual space VS so that the robot VR1 can be seen through the area image VR2. Then, the display control section 361 generates an area display image, which is an image in the case of viewing the area in the virtual space VS including the robot VR1 and the area image VR2 from a predetermined direction. The predetermined direction can be an arbitrary direction. The display control section 361 makes the area display image thus generated be displayed in at least a part of the area display screen to thereby make the display section 35 display the area represented by the area information generated in the step S140.

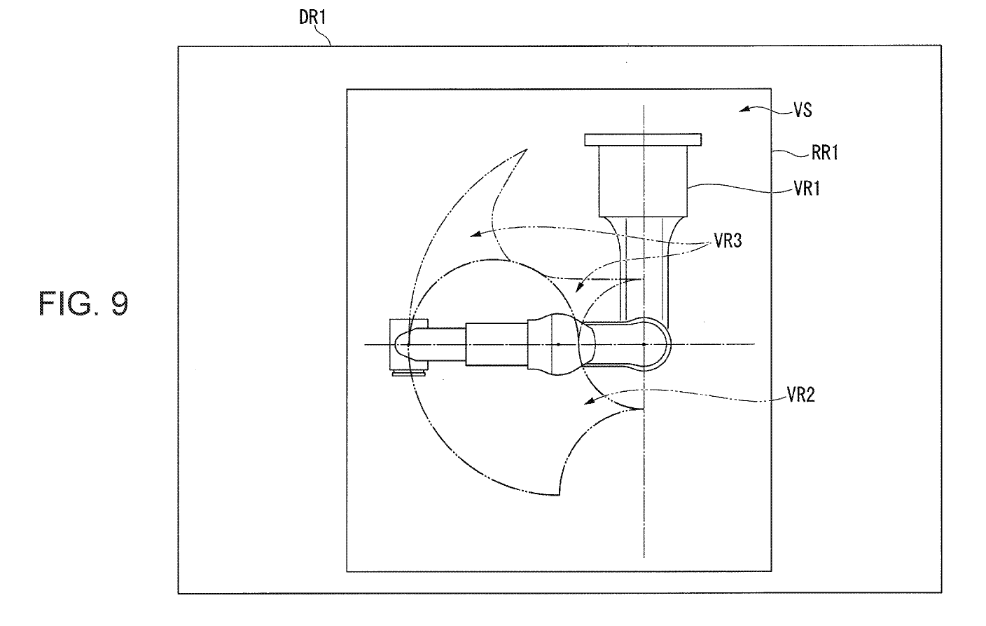

Here, the area display screen will be described with reference to FIG. 9. FIG. 9 is a diagram showing an example of the area display screen. A screen DR1 shown in FIG. 9 is an example of the area display screen. In the screen DR1, there is disposed an area display image RR1. It should be noted that in the screen DR1 shown in FIG. 9, the graphical user interface (GUI) other than the area display image RR1 such as the GUI for receiving operations from the user is omitted in order to simplify the drawing.

The area display image RR1 is a three-dimensional image showing an appearance in the virtual space VS. However, in FIG. 9, in order to simplify the drawing, the area display image RR1 is shown as a two-dimensional image showing an appearance in the virtual space VS in the case of viewing the robot VR1 toward the direction in which the second arm of the robot VR1 and the first arm of the robot VR1 appear side by side in this order along the second rotational axis AX2 of the robot VR1. It should be noted that the area display image RR1 can also be the two-dimensional image shown in FIG. 9 instead of the three-dimensional image. It should be noted that it is also possible to adopt a configuration in which an image showing another object such as the cradle BS is displayed in addition to the robot VR1 and the area image VR2 in the area display image RR1. In this case, the display control section 361 receives information representing the position at which the object is disposed, information representing the shape of the object, and so on from the user in advance.

The area image VR2 shown in FIG. 9 is an image showing the area corresponding to the first through third flags represented by the flag information received in the step S130 as described above. The area represented by the area image VR2 shown in FIG. 9 is an area corresponding to the first through third flags in the case in which the first flag is 0, the second flag is 0, and the third flag is 1. In other words, in the case in which at least one of the first through third flags is different from the flags in this case, the display control section 361 makes the area image VR2 representing a different area from the area represented by the area image VR2 shown in

FIG. 9 be displayed in the area display image RR1.

It is possible for the user to determine the area on the real space corresponding to the area image VR2 as the work area based on the relative positional relationship between the robot VR1 and the area image VR2 included in the area display image RR1 shown in FIG. 9. In other words, it is possible for the robot control device 30 to help the user to determine the work area of the robot 20. Further, it is possible for the user to dispose an object (the object O and the object G in this example), on which the robot 20 performs the operation, within the work area thus determined. As a result, it is possible for the robot control section 375 to move the control point T so that the P-point of the robot 20 does not pass through the singular point. In other words, it is possible for the robot control section 375 to make the robot 20 perform the first operation performed using the continuous path control out of the predetermined operations in the area in which the control point T can move so that the P-point of the robot 20 does not pass through the singular point.

It should be noted that the area VR3 shown in FIG. 9 is an area in which the centroid of the joint J6 rotates clockwise around the fifth rotational axis AX5 from the fourth rotational axis AX4 as much as a rotational angle larger than 90°, or an area in which the centroid rotates counterclockwise around the fifth rotational axis AX5 from the fourth rotational axis AX4 as much as a rotational angle larger than 90° in the case of viewing the robot 20 toward the direction in which the second arm L2 and the first arm L1 appear side by side in this order along the second rotational axis AX2 out of the areas represented by the area image VR2. The display control section 361 can also be provided with a configuration of displaying the area image VR2 so as to be able to distinguish the area VR3 in the area image VR2 when displaying the area image VR2, or can also be provided with a configuration of displaying the area image VR2 so as not to be able to distinguish the area VR3 in the area image VR2.

Further, the display control section 361 can also be provided with a configuration of generating the area image representing the area corresponding to the combination of the first through third flags for each of the combinations of the first through third flags, and then displaying a part or the whole of each of the area images of the respective combinations thus generated in the area display image RR1 in a superimposed manner. In this case, the display control section 361 makes the part or the whole of each of the area images of the respective combinations be displayed in the area display image RR1 so as to be able to be distinguished from each other. For example, the display control section 361 expresses the area images with respective colors, hatching, or the like different from each other to display in the area display image RR1.

Further, the display control section 361 can also be provided with a configuration capable of moving the robot VR1 disposed in the virtual space VS in the area display image RR1 based on the operation received from the user or the operation program stored in advance in the storage section 32. In this case, the display control section 361 displays the area image corresponding to the flag information in the area display image RR1 based on the flag information corresponding to the operation of the robot VR1 in the virtual space VS without referring to, for example, the first through third flags represented by the flag information received in the step S130. For example, in the case in which the operation of the robot VR1 due to the operation or the operation program is an operation accompanied by each of the 11-th operation, the 21-st operation, and the 32-nd operation, the display control section 361 determines that the first flag is 0, the second flag is 0, and the third flag is 1, and makes the area image corresponding to these flags be displayed in the area display image RR1. Further, in the case in which the P-point of the robot VR1 passes through the singular point in the operation of the robot VR1 due to the operation or the operation program, it is also possible for the display control section 361 to switch the area image displayed in the area display image RR1 in accordance with the operation of the robot VR1. For example, during the period in which the robot VR1 performs the operation accompanied by each of the 11-th operation, the 21-st operation, and the 32-nd operation due to the operation or the operation program, the display control section 361 displays the area image corresponding to the operation in the area display image RR1, and when the operation of the robot VR1 changes from the operation accompanied by each of the 11-th operation, the 21-st operation, and the 32-nd operation to an operation accompanied by each of the 11-th operation, the 22-nd operation, and the 32-nd operation, the display control section 361 switches the area image displayed in the area display image RR1 to the area image corresponding to the present operation (redisplays the area image corresponding to the present operation). It should be noted that in the case in which the P-point of the robot VR1 passes through the singular point in the operation of the robot VR1 due to the operation or the operation program, it is not required for the display control section 361 to switch the area image displayed in the area display image RR1 in accordance with the operation of the robot VR1.

After the process in the step S150 is performed, the display control section 361 determines (step S160) whether or not an operation for terminating the display of the screen DR1 has been performed. In the case in which the display control section 361 has determined that the operation for terminating the display of the screen DR1 has not yet been performed (NO in the step S160), the robot control section 375 makes the transition to the step S130, and waits until the flag information is received again from the screen DR1. Then, in the case in which the robot control section 375 has received the flag information once again, the robot control section 375 executes the process of the steps S130 through S160 based on the flag information newly received. On this occasion, the display control section 361 switches the area display image RR1 shown in FIG. 9 to the area display image newly generated (redisplays the area display image newly generated). In contrast, in the case in which the display control section 361 has determined that the operation for terminating the display of the screen DR1 has been performed (YES in the step S160), the control section 36 terminates the process.

### Process of Robot Control Device for Making Robot Perform Predetermined Operation

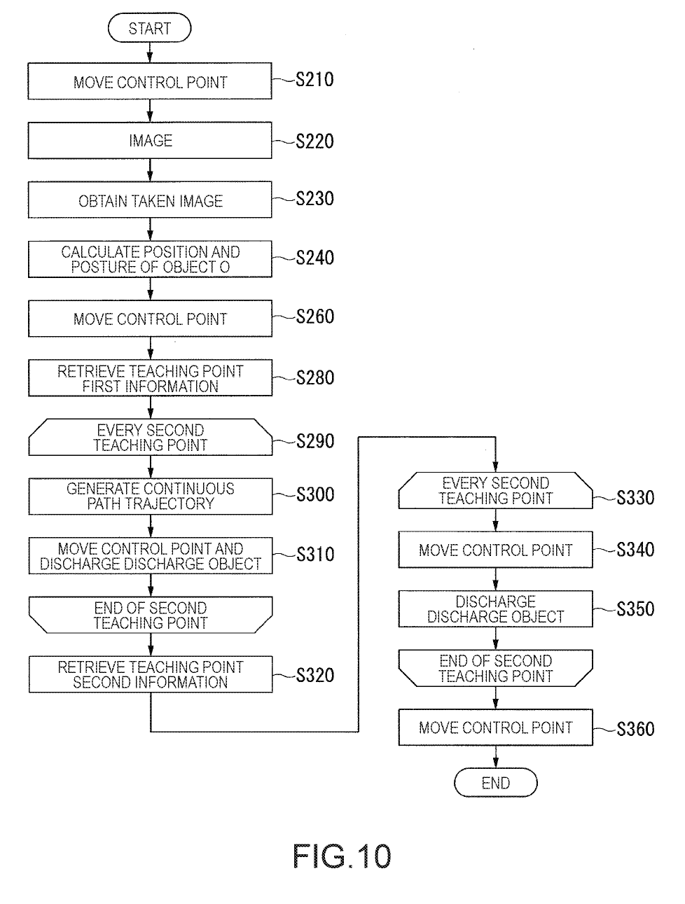

The process of the robot control device 30 for making the robot 20 perform the predetermined operation will hereinafter be described with reference to FIG. 10. FIG. 10 is a flowchart showing an example of a flow of the process of the robot control device 30 for making the robot 20 perform the predetermined operation. It should be noted that there will hereinafter be described the case in which the user has disposed the object O and the object G in the area (inside the area) which corresponds to the first through third flags set to the robot control section 375, and in which the control point T can move so that the P-point of the robot 20 does not pass through the singular point, based on the area display image RR1 displayed on the display section 35 due to the process of the flowchart shown in FIG. 8 in a time window prior to the execution of the flowchart shown in FIG. 10. Further, there will hereinafter be described the case in which the user makes the position and the posture of the object G coincide with the position and the posture determined in advance in the area.

The robot control section 375 moves the control point T (step S210) to make the position and the posture of the control point T coincide with an imaging position and an imaging posture determined in advance. The imaging position and the imaging posture can be any position and any posture providing the upper surface of the object O is at least included in the range, which can be imaged by the imaging section 10, in the case in which the position and the posture of the control point T coincide with the imaging position and the imaging posture.

Then, the imaging control section 363 makes (step S220) the imaging section 10 take an image of the range which can be imaged by the imaging section 10. Then, the image acquisition section 367 obtains (step S230) the taken image, which has been taken by the imaging section 10 in the step S220, from the imaging section 10. Then, the position posture calculation section 371 calculates (step S240) the position and the posture of the object O included in the taken image based on the taken image obtained by the image acquisition section 367 in the step S230. For example, the position posture calculation section 371 calculates the position and the posture from the taken image using pattern matching or the like. The position of the object O is represented by, for example, the position in the robot coordinate system RC of the origin of a three-dimensional local coordinate system not shown associated with the centroid of the object O. It should be noted that it is also possible to adopt a configuration in which the position of the object O is represented by another position associated with the object O instead thereof. The posture of the object O is represented by, for example, the direction in the robot coordinate system RC of each of the coordinate axes in the three-dimensional local coordinate system. It should be noted that it is also possible to adopt a configuration in which the posture of the object O is represented by another direction associated with the object O instead thereof.

Then, the robot control section 375 retrieves operation starting position posture information, which has been stored in advance in the storage section 32, from the storage section 32. The operation starting position posture information is information representing a relative position and a relative posture from the position and the posture of the object O detected in the step S240 to the operation starting position and the operation starting posture. The operation starting position denotes a desired position, which the user wants the position of the control point T to coincide with, at the start of the first operation out of the predetermined operations. The operation starting posture denotes a desired posture, which the user wants the posture of the control point T to coincide with, at the start of the first operation. The robot 20 starts discharging the discharge object from the discharge section D in the state in which the position and the posture of the control point T coincide with the operation starting position and the operation starting posture at the start of the first operation. Here, the operation starting position and the operation starting posture are the position and the posture with which the discharge section D can discharge the grease at a position, which corresponds to the operation starting position and the operation starting posture, and is located on the upper surface of the object O, in the case in which the position and the posture of the control point T coincide with the operation starting position and the operation starting posture. Further, the position located on the upper surface is the desired position at which the user wants to discharge (i.e., apply) the grease. The robot control section 375 moves the control point T based on the operation starting position posture information retrieved from the storage section 32 to make (step S260) the position and the posture of the control point T coincide with the operation starting position and the operation starting posture represented by the operation starting position posture information.

Then, the robot control section 375 retrieves (step S280) the teaching point first information, which is the teaching point information used in the first operation out of the teaching point information stored in advance in the storage section 32, from the storage section 32. Here, a certain second teaching point represented by the teaching point first information is a teaching point with which the discharge section D can discharge the grease at the position corresponding to the second teaching point and located on the upper surface of the object O in the case in which the control point T coincides with the second teaching point. Further, the position located on the upper surface is the desired position at which the user wants to discharge (i.e., apply) the grease. Then, the robot control section 375 selects one or more second teaching points represented by the teaching point first information retrieved in the step S280 one by one in the ascending order of the numbers of the second teaching points as a target second teaching point, and then repeatedly executes (step S290) the process in the steps S300 and S310 for each of the target second teaching points thus selected.

After the target second teaching point is selected in the step S290, the robot control section 375 obtains the information representing the rotational angles of the respective joints J1 through J6 from the robot 20, and then calculates the position and the posture of the present control point T as the position and the posture of the first teaching point using the direct kinematics based on the information thus obtained. Then, the robot control section 375 generates (step S300) the continuous path trajectory based on the first teaching point thus calculated, and the target second teaching point selected in the step S290. Then, the robot control section 375 starts making each of the joints J1 through J6 perform the continuous path operation based on the continuous path trajectory generated in the step S300 to thereby move the control point T from the first teaching point to the target second teaching point. On this occasion, the robot control section 375 controls the discharge control section 365 to make (step S310) the discharge section D discharge the grease while the control point T is moving.

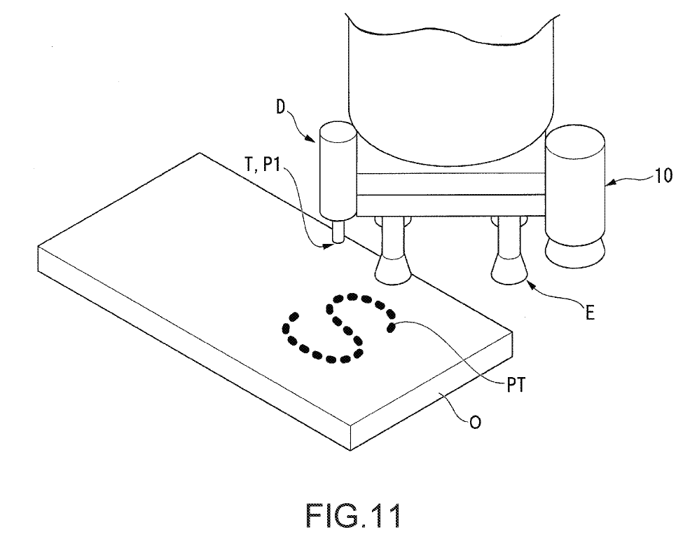

As described above, by repeating the process of the steps S290 through S310, it is possible for the robot control device 30 to make the control point T coincide with each of the one or more second teaching points represented by the teaching point first information in the ascending order of the numbers of the second teaching points using the continuous path control, and thus make the robot 20 perform the operation of making the discharge section D discharge the grease on the upper surface of the object O along the continuous path trajectory as the first operation. Here, the repeated process in the steps S290 through S310 will be described with reference to FIG. 11.

FIG. 11 is a diagram showing an example of an appearance in which the position and the posture of the control point T coincide with the operation starting position and the operation starting posture. The position and the posture of the control point T shown in FIG. 11 coincide with a first teaching point P1 representing the operation starting position and the operation starting posture. The robot control section 375 in the step S310 makes the discharge section D discharge the grease while moving the control point T along the continuous path trajectory generated in the step S300. As a result, the robot 20 discharges the grease from the discharge section D along a dotted line PT drawn on the upper surface of the object O shown in FIG. 11. The part in which the dotted line PT is drawn out of the upper surface of the object O is an aggregate of the desired positions at which the user wants to discharge (apply) the grease. In the example shown in FIG. 11, the shape of the dotted line PT is an S shape. In other words, the robot control section 375 in this example moves the control point T in the S-shape due to the repeated process in the steps S290 through S310, and discharges the grease on the upper surface of the object O so that the grease has the S-shape.

It should be noted that in the repeated process in the steps S290 through S310, the robot control section 375 generates the path in the continuous path control based on the position and the posture of the object O calculated in the step S240. In other words, the process in the steps S240 through S310 by the robot control section 375 can be said to be a process of calculating the position and the posture of the object O based on the taken image obtained by imaging the object O, correcting the continuous path trajectory as the path in the continuous path control based on the position and the posture thus calculated, moving the control point T using the continuous path control along the continuous path trajectory thus corrected, and making the robot 20 perform a predetermined operation. Thus, it is possible for the robot control device 30 to make the robot 20 accurately perform the predetermined operation even in the case in which the position and the posture of the object O are shifted from the desired position and the desired posture. Here, the robot control device 30 can also be provided with a configuration of calculating only the posture of the object O in the step S240. In this case, the user makes the position of the object O coincide with a predetermined position on an upper surface of the workbench TB when disposing the object O on the upper surface. Further, the information representing the position is stored in the robot control device 30 in advance by the user. Further, the robot control device 30 calculates the posture of the object O based on the taken image obtained by imaging the object O, corrects the continuous path trajectory as the path in the continuous path control based on the posture thus calculated, moves the control point T using the continuous path control along the continuous path trajectory thus corrected, and makes the robot 20 perform a predetermined operation.

After the repeated process in the steps S290 through S310 has been performed, the robot control section 375 retrieves (step S320) the teaching point second information, which is used in the second operation out of the teaching point information stored in advance in the storage section 32, from the storage section 32. Here, a certain second teaching point represented by the teaching point second information is a teaching point with which the discharge section D can discharge the grease at the position corresponding to the second teaching point and located on the side surface of the object G in the case in which the control point T coincides with the second teaching point. Further, the position located on the side surface is the desired position at which the user wants to discharge (i.e., apply) the grease. One or more second teaching points represented by the teaching point second information are one or more desired second teaching points which the user wants to make the position of the control point T coincide therewith in the second operation. In other words, the robot 20 discharges the grease from the discharge section D to the side surface of the object G in the state in which the control point T coincides with the second teaching point for each of the one or more second teaching points represented by the teaching point second information.

Then, the robot control section 375 selects one or more second teaching points represented by the teaching point second information retrieved in the step S320 one by one in the ascending order of the numbers of the second teaching points as a target second teaching point, and then repeatedly executes (step S330) the process in the steps S340 and S350 for each of the target second teaching points thus selected.

After the target second teaching point is selected in the step S330, the robot control section 375 moves the control point T to make (step S340) the position and the posture of the control point T coincide with the position and the posture of the target second teaching point . It should be noted that the robot control section 375 can also be provided with a configuration of generating the continuous path trajectory using the continuous path control described above based on the first teaching point and the target second teaching point when moving the control point T in the step S340, or can also be provided with a configuration of generating a continuous positioning trajectory using continuous positioning control (point to point (PTP) control) based on the first teaching point and the target second teaching point. In the case in which the robot control section 375 generates the continuous path trajectory, the robot control section 375 moves the control point T along the continuous path trajectory thus generated. Further, in the case in which the robot control section 375 generates the continuous positioning trajectory, the robot control section 375 moves the control point T along the continuous positioning trajectory thus generated.

In the continuous positioning control, the robot control section 375 calculates the rotational angles of the respective joints J1 through J6 in the case in which the control point T coincides with the first teaching point, namely the rotational angles of the respective present joints J1 through J6, as starting point rotational angles. Further, the robot control section 375 calculates the rotational angles of the respective joints J1 through J6 in the case in which the control point T coincides with the target second teaching point as end-point rotational angles. The robot control section 375 solves a joint space interpolation trajectory generation problem based on the starting point rotational angle and the end-point rotational angle thus calculated to generate (calculate) the continuous positioning trajectory. The continuous positioning trajectory is the rotational angles changing with the elapsed time taken by the control point T for moving from the first teaching point to the target second teaching point, and is the change in the rotational angles of the respective joints J1 through J6 expressed as the function of the elapsed time. The robot control section 375 rotates each of the joints J1 through J6 based on the continuous positioning trajectory thus generated to thereby move the control point T from the first teaching point to the second teaching point.

After the process of the step S340 is performed, the robot control section 375 controls the discharge control section 365 to make (step S350) the discharge section D discharge the grease.

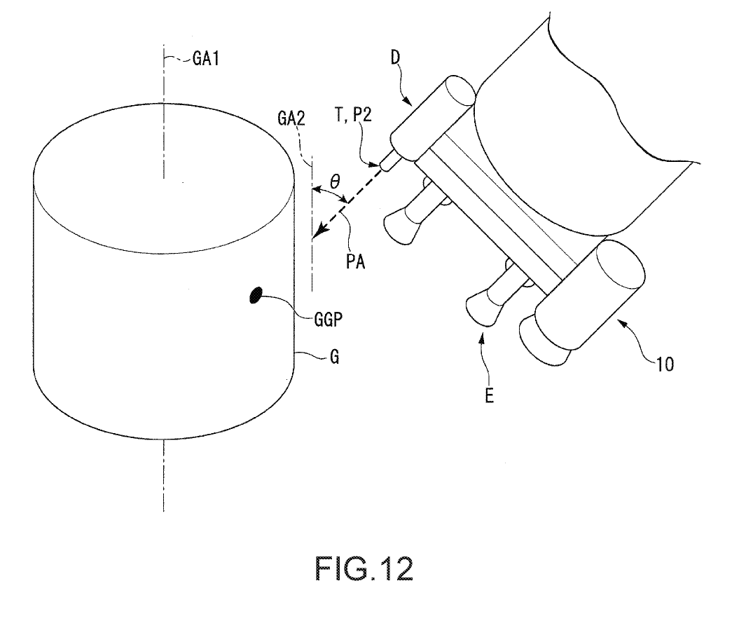

As described above, by repeating the process of the steps S330 through S350, the robot control device 30 makes the control point T coincide with each of the one or more second teaching points represented by the teaching point second information in the ascending order of the numbers of the second teaching points. Further, it is possible for the robot control device 30 to discharge the grease from the discharge section D to the side surface of the object G every time the control point T coincides with each of the second teaching points . Here, the repeated process in the steps S330 through S350 will be described with reference to FIG. 12.

FIG. 12 is a diagram showing an example of an appearance in which the control point T coincides with a certain second teaching point out of the one or more second teaching points represented by the teaching point second information. A point P2 shown in FIG. 12 is an example of the second teaching point. The position and the posture of the control point T shown in FIG. 12 coincide with those of the point P2. The robot control section 375 in the step S340 moves the control point T to make the position and the posture of the control point T coincide with the position and the posture of the point P2, which is selected as the target second teaching point in the step S330. Here, in the case in which the point P2 and the control point T coincide with each other, a direction PA in which the grease is discharged from the discharge section D, namely the direction PA in which the needle section of the discharge section D extends, is tilted as much as an angle θ with respect to a central axis GA1 of the object G as the gear wheel. Here, an auxiliary line GA2 shown in FIG. 12 is a line parallel to the central axis GA1. The angle 0 is an angle from the auxiliary line GA2 to a straight line not shown crossing the auxiliary line GA2 along the direction PA, and is an angle defined in the clockwise direction. It should be noted that the angle θ can also be an arbitrary angle. Thus, it is possible for the robot control device 30 to make the robot 20 discharge the grease from the angle desired by the user to the side surface of the object G. As a result, it is possible for the robot control device 30 to accurately perform the operation of discharging the grease at the position desired by the user with the robot 20.

After the repeated process in the steps S330 through S350 has been performed, the robot control section 375 retrieves operation ending position posture information, which is stored in advance in the storage section 32, from the storage section 32. The operation ending position posture information is information representing the operation ending position and the operation ending posture. The operation ending position denotes a desired position, which the user wants the position of the control point T to coincide with, at the end of the predetermined operation. The operation ending posture denotes a desired posture, which the user wants the posture of the control point T to coincide with, at the end of the predetermined operation. The robot control section 375 moves the control point T to make (step S360) the position and the posture of the control point T coincide with the operation ending position and the operation ending posture represented by the operation ending position posture information thus retrieved. Then, the control section 36 terminates the process.

It should be noted that in the step S360, the robot control section 375 can also be provided with a configuration of suctioning the object O with the end effectors E to remove the material to a predetermined material removing area (or feed the material from a predetermined material feeding area). In this case, the robot control section 375 can be provided with, for example, a configuration of imaging the object O with the imaging section 10 and suctioning the object O based on the taken image obtained by imaging the object O, or can also be provided with a configuration of suctioning the object O using another method. It should be noted that in the step S360, the robot control section 375 can also be provided with a configuration of suctioning the object G with the end effectors E to remove the material to a predetermined material removing area (or feed the material from a predetermined material feeding area). In this case, the robot control section 375 can be provided with a configuration of imaging the object G with the imaging section 10 and suctioning the object G based on the taken image obtained by imaging the object G, or can also be provided with a configuration of suctioning the object G using another method.

As described above, the robot control device 30 displays the area in which a second predetermined position (the control point T in this example) of the robot 20 can move so that a first predetermined position (the P-point in this example) of the robot 20 does not pass through the singular point. Thus, it is possible for the robot control device 30 to help the user to determine the work area of the robot 20.

Further, in the robot control device 30, the first predetermined position is the same position as the second predetermined position. Thus, it is possible for the robot control device 30 to provide the user with the area in which the first predetermined position can move as a candidate for the work area of the robot 20.

Further, the robot control device 30 moves the second predetermined position using the continuous path control in the area in which the second predetermined position can move so that the first predetermined position of the robot 20 does not pass through the singular point. Thus, it is possible for the robot control device 30 to determine the area in which the second predetermined position can move so that the first predetermined position does not pass through the singular point as the work area of the robot 20, and make the robot 20 perform a predetermined operation due to the continuous path control.

Further, the robot control device 30 corrects the path (the continuous path trajectory in this example) in the continuous path control based on the posture of the object (the object O in this example) calculated based on the taken image obtained by imaging the object, and then moves the second predetermined position with the continuous path control along the path thus corrected. Thus, it is possible for the robot control device 30 to make the robot 20 accurately perform the predetermined operation even in the case in which the posture of the object is shifted from the desired posture.

Further, in the robot control device 30, the work area of the robot 20 is the inside of the area in which the second predetermined position of the robot 20 can move so that the first predetermined position of the robot 20 does not pass through the singular point. Thus, it is possible for the robot control device 30 to make the robot 20 perform a predetermined operation in the inside of the area in which the second predetermined position can move so that the first predetermined position does not pass through the singular point.

Further, the robot control device 30 displays the area in which the second predetermined position of the robot 20 provided with the discharge section (the discharge section D in this example) can move so that the first predetermined position of the robot 20 does not pass through the singular point. It is possible to help the user to determine the work area of the robot 20 provided with the discharge section D.

Further, the robot control device 30 displays the area in which the second predetermined position of the robot 20 provided with the holding section (the end effectors E in this example) can move so that the first predetermined position of the robot 20 does not pass through the singular point. Thus, it is possible for the robot control device 30 to help the user to determine the work area of the robot 20 provided with the holding section.

Further, the robot control device 30 displays the area in which the second predetermined position of the robot 20 provided with the force detection section (the force detection section 21 in this example) can move so that the first predetermined position of the robot 20 does not pass through the singular point. Thus, it is possible for the robot control device 30 to help the user to determine the work area of the robot 20 provided with the force detection section.

Further, the robot control device 30 displays the area in which the second predetermined position of the robot 20, in which an n-th arm and an (n+1)-th arm can overlap each other viewed from the axial direction of an (n+1)-th rotational axis, can move so that the first predetermined position of the robot 20 does not pass through the singular point. Here, n is an integer equal to or greater than 1. In this example, since the manipulator M has the degree of freedom of 6 axes, n is an integer in a range of 1 through 5. Thus, it is possible for the robot control device 30 to help the user to determine the work area of the robot 20, in which the n-th arm and the (n+1)-th arm can overlap each other viewed from the axial direction of the (n+1)-th rotational axis.

Further, it is possible for the robot control device 30 to help the user to determine the work area of the robot 20 in which the length of an n-th arm is longer than the length of an (n+1)-th arm.

Further, it is possible for the robot control device 30 to help the user to determine the work area of the robot 20 having an n-th arm (n is 1) disposed on a base (the base B in this example).

Further, the robot control device 30 displays the area in which the second predetermined position of the robot 20 installed in the cradle (the cradle BS) can move so that the first predetermined position of the robot 20 does not pass through the singular point. Thus, it is possible for the robot control device 30 to help the user to determine the work area of the robot 20 installed in the cradle.

Further, the robot 20 performs the predetermined operation in the work area determined by the user with the help of the robot control device 30. Thus, it is possible for the robot 20 to perform the predetermined operation while preventing the error from occurring.

Although the embodiment of the invention is hereinabove described in detail with reference to the accompanying drawings, the specific configuration is not limited to the embodiment described above, but modifications, replacement, elimination, and so on are allowed within the scope or the spirit of the invention.

Further, it is also possible to arrange that a program for realizing the function of an arbitrary constituent in the device (e.g., the robot control device 30) described hereinabove is recorded on a computer readable recording medium, and then the program is read and then performed by a computer system. It should be noted that the “computer system” mentioned here should include an operating system (OS) and hardware such as peripheral devices. Further, the “computer-readable recording medium” denotes a portable recording medium such as a flexible disk, a magneto-optical disk, a ROM, and a CD (compact disk)-ROM, and a storage device such as a hard disk incorporated in the computer system. Further, the “computer-readable recording medium” should include those holding a program for a certain period of time such as a volatile memory (a RAM) in a computer system to be a server or a client in the case of transmitting the program via a network such as the Internet, or a communication line such as a telephone line.

Further, the program described above can be transmitted from the computer system having the program stored in the storage device or the like to another computer system via a transmission medium or using a transmission wave in the transmission medium. Here, the “transmission medium” for transmitting the program denotes a medium having a function of transmitting information such as a network (a communication network) such as the Internet or a communication line (a communication wire) such as a telephone line.

Further, the program described above can be for realizing a part of the function described above. Further, the program described above can be a program, which can realize the function described above when being combined with a program recorded on the computer system in advance, namely a so-called differential file (a differential program).

The entire disclosure of Japanese Patent Application No. 2017-002412, filed Jan. 11, 2017 is expressly incorporated by reference herein.

What is claimed is:

1. A robot control device comprising:
a processor that is configured to execute computer-executable instructions so as to control a robot provided with a manipulator having a plurality of joints,
wherein the processor is configured to:
display an area, in which a second predetermined position of the robot can move so that a first predetermined position of the robot does not pass through a singular point, in a display.

2. The robot control device according to claim 1, wherein
the first predetermined position is a same position as the second predetermined position.

3. The robot control device according to claim 1, wherein
the processor is configured to move the second predetermined position in the area with continuous path control.

4. The robot control device according to claim 3, wherein
the processor is configured to correct a path in the continuous path control based on a posture of an object calculated based on a taken image obtained by imaging the object, and move the second predetermined position along the path corrected with the continuous path control.

5. The robot control device according to claim 1, wherein
a work area of the robot is an inside of the area.

6. A robotic system comprising:
a robot provided with a manipulator having a plurality of joints; and
a robot control device including a processor that is configured to execute computer-executable instructions so as to control the robot,
wherein the processor is configured to:
display an area, in which a second predetermined position of the robot can move so that a first predetermined position of the robot does not pass through a singular point, in a display.

7. The robotic system according to claim 6, wherein
the first predetermined position is a same position as the second predetermined position.

8. The robotic system according to claim 6, wherein
the processor is configured to move the second predetermined position in the area with continuous path control.

9. The robotic system according to claim 6, wherein
the processor is configured to correct a path in the continuous path control based on a posture of an object calculated based on a taken image obtained by imaging the object, and move the second predetermined position along the path corrected with the continuous path control.

10. The robotic system according to claim 6, wherein
a work area of the robot is an inside of the area.

11. The robotic system according to claim 6, wherein
the robot is provided with a dispenser.

12. The robotic system according to claim 6, wherein
the robot is provided with an end effector.

13. The robotic system according to claim 6, wherein
the robot is provided with a force sensor.

14. The robotic system according to claim 6, wherein
the robot includes
an n-th (n is an integer no lower than 1) arm capable of rotating around an n-th rotational axis, and
an (n+1)-th arm connected to the n-th arm so as to be able to rotate around an (n+1)-th rotational axis having a different axial direction from an axial direction of the n-th rotational axis, and
the n-th arm and the (n+1)-th arm can overlap each other viewed from the axial direction of the (n+1)-th rotational axis.

15. The robotic system according to claim 14, wherein
a length of the n-th arm is longer than a length of the (n+1)-th arm.

16. The robotic system according to claim 14, wherein
the n-th arm (n is 1) is disposed on a base.

17. The robotic system according to claim 15, wherein
the n-th arm (n is 1) is disposed on a base.

18. The robotic system device according to claim 6, wherein
the robot is installed in a cradle.

19. The robotic system device according to claim 7, wherein
the robot is installed in a cradle.

20. The robotic system device according to claim 8, wherein
the robot is installed in a cra
